(19) United States
(12) Patent Application Publication
(10) Pub. No.: US 2004/0196209 A1
(43) Pub. Date: Oct. 7, 2004

(54) PORTABLE COMPUTER WITH AN ADD-ON LIQUID CRYSTAL DISPLAY MONITOR MODULE

(76) Inventors: Jiann-Jou Chen, Taipei Hsien (TW); Chu-Chia Tsai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,078

(22) Filed: Sep. 7, 2003

(30) Foreign Application Priority Data
Apr. 7, 2003 (TW) 092205410

(51) Int. Cl. G09G 5/00

(52) U.S. Cl. 345/1.1

(57) ABSTRACT

A portable computer with an add-on liquid crystal display monitor module. A portable computer has a first housing, a first display screen for displaying images, a display controller for outputting a first display signal to initiates the first display screen, and an output port positioned on the first housing for transmitting a second display signal generated from the display controller. A display monitor module has a second housing with a latch device used for removably fixing the second housing on the first housing, a second display screen for displaying images, and an input port removably connected to the output port of the portable computer for receiving the second display signal to initiate the second display screen.

### BACKGROUND OF INVENTION

1. Field of the Invention

The present invention relates to a laptop computer. In particular, the present invention discloses a laptop computer with an add-on liquid crystal display (LCD) monitor module.

2. Description of the Prior Art

With a quick development on semiconductor process, density of components inside an integrated circuit (IC) is accordingly increased. Therefore, an actual size of the IC becomes smaller, and power consumption of the IC becomes lower. At the same time, the IC becomes more powerful. Concerning a computer device, a central processing unit (CPU) is an IC for controlling overall operation of the computer device. An operating clock used to initiates the CPU is greater than one gigahertz (GHz) now owing to an advance on the semiconductor process. The CPU is powerful enough to perform plenty of instructions per second so that computer devices are commonly adopted by companies to function as servers for improving working efficiency of workers in offices. In addition, the computer device is also used at home to provide a user with multimedia amusements. Generally speaking, the computer devices can be roughly divided into desktop computers and portable computers. Because the portable computer has virtues such as a small size and a light weight, the portable computer, a laptop computer for example, makes a user capable of utilizing the portable computer to process data conveniently.

Please refer to FIG. 1, which is a diagram of a prior art computer system 10. The computer system 10 includes a laptop computer 12, an external display device 14, an external digitizer 16, and an external mouse 18. In addition, the laptop computer 12 has a display screen 20, and the display device 14 also has a display screen 22. When the laptop computer 12 running in a window-based operating system, the laptop computer 12 can simultaneously perform a plurality of applications and multi-tasking management with the help of a powerful CPU, provided by the operating system. For instance, there are three windows A1,A2,A3 shown on the display screen 20, and the windows A1,A2,A3 respectively correspond to different applications. In addition, a task bar 24 is displayed on the display screen 20 for recording icons A1′A2′A3′,A4 corresponding to activated applications. Therefore, the user can easily manipulate one application through selecting a corresponding icon displayed on the task bar 24. For example, when the user selects the icon A1 on the task bar 24, the window A1 is then displayed on top. That is, parts of the contents shown by the windows A2,A3 are covered by the window A1. If the user maximizes the window A1 to manipulate a corresponding application with a maximum display area, the user is unable to know operation results displayed within windows A2,A3 when other applications runs. The user, therefore, has to sequentially select icons A2′,A3 corresponding other applications with the help of the task bar 24 to make windows A2,A3 displayed accordingly on top. Then, the user is capable of knowing current operation statuses associated with other applications. For instance, after the user activates an image processing application shown in the window A1 for rendering a 3D image, the user can activates a word processing application shown in the window A2 for editing a document. The laptop computer 12 performs the image processing application and the word processing application at the same time through a multi-tasking management. However, when the window A2 covers the window A1, the user can not know if the operation for rendering the 3D image is finished unless the windows A1 is selected by the user to be displayed on top. It is obvious that the above-mentioned operation of switching windows forces the current work of editing the document be interrupted. Therefore, working efficiency of the user is greatly affected.

In order to improve an unprodutive computing-environment owing to only one display screen 20 installed on the laptop computer 12, the external display device 14 is utilized to provide the laptop computer 12 with an additional display screen 22. It is well-known that a display controller commonly supports a dual channel display mode, that is, the display controller is capable of initiating plurality of display devices. With a proper control for a display driver and related software, the laptop computer 12 can outputting images on two display screens 20,22 at the same time. As shown in FIG. 1, a window A4 is shown on the display screen 22. Therefore, when an application corresponding to the window A4 runs, the display screen 22 is used to show an operation status on the window A4. For instance, after the user activates an image processing application shown in the window A4 for rendering a 3D image, the user can activates a word processing application shown in the window A1 for editing a document. The laptop computer 12 performs the image processing application and the word processing application at the same time through a multi-tasking management. The windows A4,A1 are respectively shown on different display screens 20,22. That is, the window A4 and A1 each displays the contents respectively. Therefore, when the user edits the document within the window A1, the user is capable of observing a whole process of rendering the 3D image and a final rendering result with the help of the display screen 22. In other words, the user does not need to frequently switch the windows A1,A4, and the document editing operation is no longer be interrupted. In the end, working efficiency of the user is then greatly improved.

However, the external display device 14 is a stand-alone display monitor such as a liquid crystal display monitor. The display device 14 has a frame 30 and a stand 32. Therefore, the display device 14 occupies much room and is not convenient for the user to carry it. In addition, the display device 14 requires a long cable to be electrically connected to the laptop computer 12. If a connector positioned at one terminal of the cable does not compatible with a connector type associated with a video output port on the laptop computer 12, an additional adapter is required to correctly connect the display device 14 and the video output port of the laptop computer 12. For example, the video output connector complies with a D-sub connector type, but the connector of the cable complies with a DVI connector type. Therefore, the user needs to connect the D-sub connector type and the DVI connector type through a proper adapter. In other words, it is not convenient for the user to link the external display device 14 and the laptop computer 12.

The laptop computer 12 further has a touchpad 26 and a keyboard 28 to function as input devices. The touchpad 26 is used to control movement of a cursor and selection of icons, and the keyboard 28 is used by the user to key in characters. Because it is not easy to precisely control movement of the cursor by the touchpad 26, the laptop computer 12 can utilize an external mouse 18 instead to conveniently control movement of the cursor. However, when the user uses the laptop computer 12 to perform an image processing application, it is not easy for the user to define areas required to be processed and draw contours of images. Therefore, the laptop computer 12 can utilize an external digitizer 16 to assist the mouse 18 in moving the cursor. For instance, the user can define areas required to be processed and draw contours of images intuitively on the digitizer 16, and then the corresponding results are directly shown on the display screen 20. In addition, the user is capable of keying in characters through the digitizer 16 instead of the keyboard 28.

However, it is well-known that the digitizer 16 and the display screen 20 needs to activate an orientation adjustment before the digitizer 16 can correctly work. That is, a mapping relation between positions on the digitizer 16 and the corresponding positions on the display screen 20 needs to be correctly set. Therefore, precision of the mapping relation between the digitizer 16 and the display screen 20 becomes a serious problem when the user uses the external digitizer 16. In other words, it is not convenient for the user to precisely adjust the desired mapping relation between the digitizer 16 and the display screen 20.

### SUMMARY OF INVENTION

It is therefore a primary objective of this invention to provide a laptop computer with an add-on LCD monitor module.

Briefly summarized, the preferred embodiment of the present invention discloses a computer system that has a computer host and a display module. The computer host includes a first housing, a first display screen disposed on the first housing for displaying images, a display controller electrically connected to the first display screen for outputting a first video signal to initiates the first display screen to display images corresponding to the first video signal, and an output port disposed on the first housing, the output port being electrically connected to the display controller for transmitting a second video signal generated from the display controller. The display module includes a second housing, a latch device disposed on the second housing being capable of removably fixing the second housing on the first housing, a second display screen disposed on the second housing for display images, and an input port being capable of removably connecting the output port of the computer host for receiving the second video signal to initiates the second display screen to display images corresponding to the second video signal.

It is an advantage of the present invention that an LCD monitor module removably installed on a housing of a laptop computer. The LCD monitor module is a convertible structure so that a user is convenient to carry the laptop computer along with the LCD monitor module. The LCD monitor module provides the laptop computer with another display screen for supporting a dual channel display mode. At the same time, the LCD monitor module also provides the laptop computer with a digitizer for supporting a handwriting input. Because the digitizer is parallel to the display screen, the digitizer and the display screen, therefore, are precisely orientated. Furthermore, the LCD monitor module can also be fixed on a specific cradle to function as a standard LCD monitor. Therefore, when the user does not add the LCD monitor module to the laptop computer, the spare LCD monitor module installed on the cradle then becomes a display device for other computer hosts.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a prior art computer system.

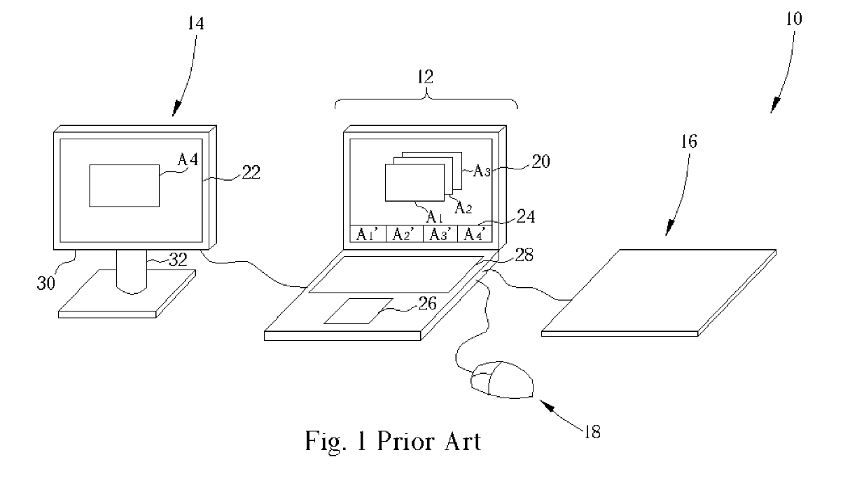

FIG. 2 is a computer system according to the present invention.

FIG. 3 is a perspective view of a top housing.

FIG. 4 is a first structure diagram of a LCD monitor module shown in FIG. 2.

FIG. 5 is a diagram showing a LCD screen shown in FIG. 2 moved to a first location.

FIG. 6 is a diagram showing the LCD screen shown in FIG. 2 moved to a second location.

FIG. 7 is a diagram showing the LCD screen shown in FIG. 2 moved to a third location.

FIG. 8 is a second structure diagram of the LCD monitor module shown in FIG. 2.

### DETAILED DESCRIPTION

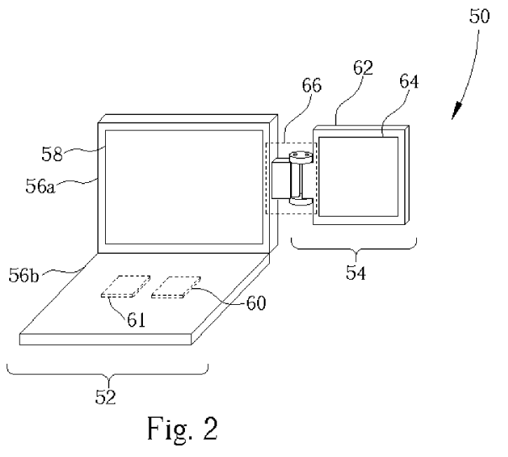

Please refer to FIG. 2, which is a computer system 50 according to the present invention. The computer system 50 includes a laptop computer 52 and a liquid crystal display (LCD) monitor module 54. The laptop computer 52 has a top housing 56a, a bottom housing 56b, an LCD screen 58, a display controller 60, and a processor 61. The LCD monitor module 54 has a housing 62, an LCD screen 64, and a latch device 66. With regard to the housing 56, the top housing 56a surrounds the LCD screen 58 for protecting, supporting, and fixing the LCD screen 58, and the bottom housing 56b is used to protect kernel components of the laptop computer 52. For example, a motherboard with the installed display controller 60 and the installed processor 61 are protected by the bottom housing 56b. The display controller 60 supports a dual channel display mode. Therefore, the display controller 60 can be used to initiates two display devices at the same time. For the LCD monitor module 54, the housing 62 is used for protecting, supporting, and fixing the LCD screen 64, and the latch device 66 is used to fix the housing 62 on the top housing 56a of the laptop computer 52.

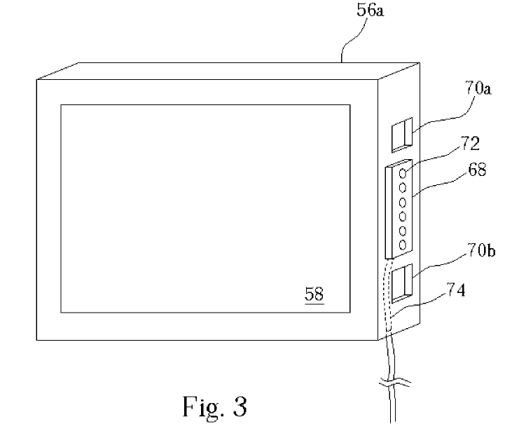

Please refer to FIG. 3, which is a perspective view of the top housing 56a. An output port 68 and a plurality of connecting devices 70a, 70b are positioned on a surface of the top housing 56a. There are a plurality of receiving holes 72 disposed on the output port 68, and are electrically connected to the display controller 60 and the processor 61 shown in FIG. 2 through a cable 74. The display controller 60 not only initiates the LCD screen 58, but also transfers video data, horizontal synchronization signal, and vertical synchronization signal to the output port 68.

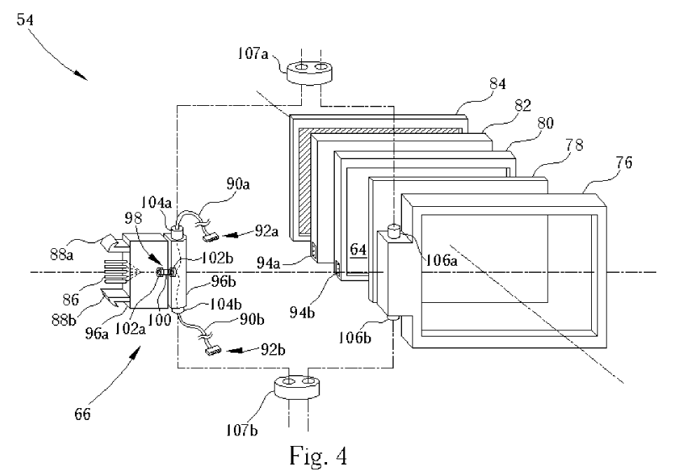

Please refer to FIG. 4 in conjunction with FIG. 3. FIG. 4 is a first structure diagram of the LCD monitor module 54 shown in FIG. 2. The LCD monitor module 54 includes a first frame 76, a protective glass 78, an LCD device 80, a digitizer 82, a second frame 84, and a latch device 66. The first frame 76 and the second frame 84 are used to establish the housing 62 of the LCD monitor module 54 shown in FIG. 2. In order to protect the LCD screen 64 on the LCD device 80, a transparent protective glass 78, generally speaking, is disposed above the LCD screen 64. It is noteworthy that the LCD screen 64 is commonly called an LCD panel for showing images. In order to conveniently describe operation of the LCD monitor module 54, only the structure diagram shown in FIG. 4 draws the protective glass 78. However, in other drawings, the LCD screen 64 is directly used to represent a display surface for simplicity. In the preferred embodiment, the digitizer 82 is an electromagnetic digitizer. It is well-known that the electromagnetic digitizer in not transparent, and the electromagnetic digitizer needs to be disposed behind the LCD screen 64. However, if the digitizer 82 is a resistive digitizer, the digitizer 82 has to be disposed before the LCD screen 64 so that a user can press the digitizer 82 successfully. Because the resistive digitizer is transparent, the digitizer 82 does not affect images displayed on the LCD device 80. With proper placement, the digitizer 82 can be an electromagnetic digitizer or a resistive digitizer.

A plurality of protruding pins 86 and two connecting devices 88a, 88b are positioned on the latch device 66. The protruding pins 86 can be plugged into the receiving holes 72 shown in FIG. 3 so that the LCD monitor module 54 and the laptop computer 52 are electrically connected. The connecting devices 88a,88b are adapted to the corresponding connecting devices 70a, 70b for fixing the LCD monitor module 54 on the top housing 56a of the laptop computer 52. In addition, two cables 90a,90b are both electrically connected to the protruding pins 86. One terminal of the cable 90a has a connector 92a used to connect the input port 94a of the digitizer 82, and one terminal of the cable 90b has a connector 92b used to connect an input port 94b of the LCD device 80. With regard to the LCD device 80, the LCD device 80 is electrically connected to the display controller 60 of the laptop computer 52 through cables 74,90b, receiving holes 72, protruding pins 86, and the connector 92b. Concerning the digitizer 82, the digitizer 82 is electrically connected to the processor 61 of the laptop computer 52 through cables 74, 90a, receiving holes 72, protruding pins 86, and the connector 92a. In addition, the latch device 86 includes two housings 96a, 96b and a pivot unit 98 used to rotationally connect the housing 96a and the housing 96b. The pivot unit 98 comprises a pivot 100 and two fixing elements 102a, 102b, wherein the fixing element 102a is connected to the housing 96a, and the fixing element 102b is connected to the housing 96b. In other words, with the help of the pivot 100, the housing 96a and the housing 96b can be relatively rotated. Two fixing cylinders 104a, 104b are disposed on the housing 96b, and other fixing cylinders 106a, 106b are positioned on the first frame 76. When the connecting unit 107a is connected to the fixing cylinders 104a, 106a, and the connecting unit 107b is connected to the fixing cylinders 104b, 106b, the LCD device 80 can be successfully installed on the latch device 86. In addition, fixing cylinders 104a, 104b, 106a, 106b further function as pivots. That is, the first frame 76 and the housing 96b can be relatively rotated. Therefore, with the help of the pivot 100 and the fixing cylinders 104a, 104b, 106a, 106b, the user is capable of randomly adjusting a location associated with the LCD screen 64.

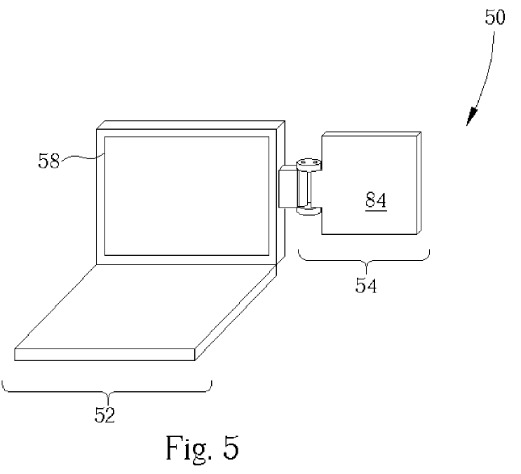

Please refer to FIG. 5 in conjunction with FIG. 4. FIG. 5 is a diagram showing the LCD screen 64 shown in FIG. 2 moved to a first location. After the latch device 66 fixes the LCD monitor module 54 on the laptop computer 52, the user is capable of rotating the housing 96b and the housing 96a through the pivot unit 98. It is noteworthy that the housing 96a is fixed on the top housing 56a of the laptop computer 52 through the connecting devices 88a, 88b. Therefore, if the housing 98b is rotated, the housing 62 having the LCD device 80 inside is accordingly rotated. As shown in FIG. 5, both of the second frame 84 and the LCD screen 58 of the laptop computer 52 face the same direction. In other words, the LCD screen 64 and the LCD screen 58 face opposite directions. As mentioned above, the display controller 60 supports a dual channel display mode. When a user operates the laptop computer 52, the user can activate an application through the laptop computer 52. Then, the contents displayed within the window corresponding to the application can be shown on both of the LCD screen 58 and the LCD screen 64. Therefore, when the user operates the application shown on the LCD screen 58, another user can view the overall process associated with the application and the final result of the application through the LCD screen 64. That is, if the LCD screen 64 is moved to the first location as shown in FIG. 5, a user such as a sales person can conveniently use the computer system 50 for briefing or demonstrating a produce to another user such as a consumer. In addition, the user also can use the laptop computer 52 to active two applications. The LCD screen 58 and the LCD screen 64 are respectively used to show contents in different windows corresponding to the two applications. For instance, the above-mentioned applications are a word processing application and a media playback application. Therefore, when a user manipulates the word processing application to edit a document within a window shown on the LCD screen 58, the laptop computer 52 enables a multi-masking management to perform the media playback application for playing a media file such as a movie film on the LCD screen 64. Therefore, when the LCD screen 64 is moved to the first location shown in FIG. 5, the computer system 50 allows two different users to conveniently view display contents shown on different LCD screens 58, 64.

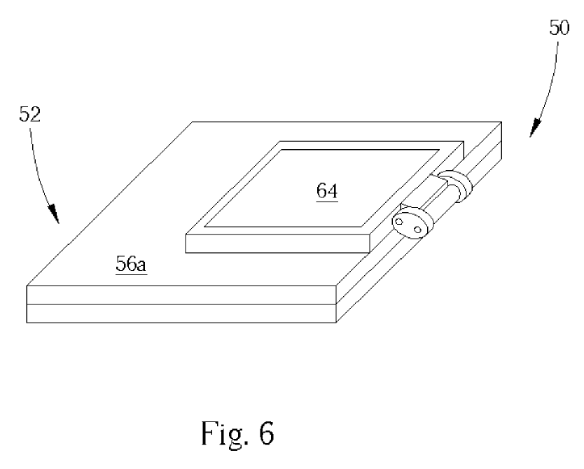

Please refer to FIG. 6 in conjunction with FIG. 4. FIG. 6 is a diagram showing the LCD screen 64 shown in FIG. 2 moved to a second location. After the latch device 66 fixes the LCD monitor module 54 on the laptop computer 52, the user is capable of rotating the housing 62 and the housing 96b through the fixing cylinders 104a, 104b, 106a, 106b. Therefore, if the housing 98b is rotated, the housing 62 having the LCD device 80 inside is accordingly rotated. Finally, the second frame 84 contacts the top housing 56a. As shown in FIG. 6, the LCD monitor module 54 has the digitizer 82 functioning as an input device. After the LCD monitor module 54 is adapted to the laptop computer 52, a user can install an operating system supporting a well-known tablet PC into the laptop computer 52. Therefore, the laptop computer 52 can be used as a tablet PC. The tablet PC provides the user with a convenient platform that simulates handwriting written on a paper. Therefore, the user communicates with a computer intuitively. After the LCD monitor module 54 provides the laptop computer 52 with a digitizer 82, the user can directly write on the LCD screen 64. Then, the digitizer 82 transmits corresponding signals to the laptop computer 52. That is, handwriting of the user is stored by an image, or is converted into characters as the characters inputted by keyboard 28. In addition, the digitizer 82 can also provide operations such as activating an application, choosing characters, or selecting a menu originally performed by the mouse 18 or the keyboard 28.

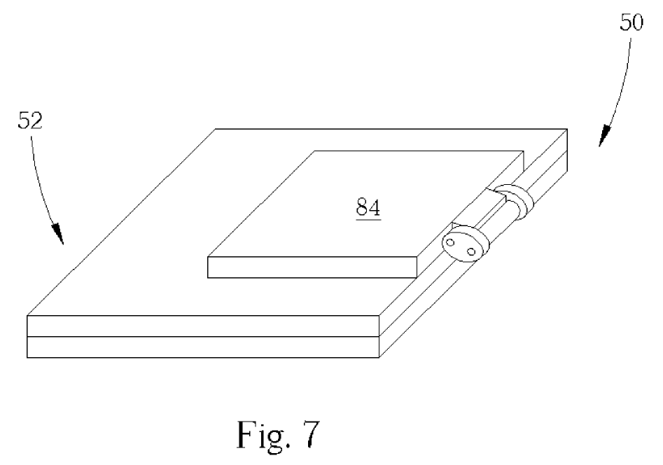

Please refer to FIG. 7 in conjunction with FIG. 4. FIG. 7 is a diagram showing the LCD screen 64 shown in FIG. 2 moved to a third location. After the latch device 66 fixes the LCD monitor module 54 on the laptop computer 52, the user not only is capable of rotating the housing 96a and the housing 96b through the pivot unit 98, but also is capable of rotating the housing 62 and the housing 96b through the fixing cylinders 104a, 104b, 106a, 106b. Therefore, the user first moves the LCD screen 64 to the first location shown in FIG. 5, and then rotates the housing 96a and the housing 96b through the pivot unit 98. Therefore, the LCD screen 64 is located between the second frame 84 and the top housing 52. That is, when the user does not use the LCD screen 64 and the digitizer 82 provided by the LCD monitor module 54, the user makes use of the exposed second frame 84 to protect internal components of the LCD monitor module 54. In addition, the LCD monitor module 54 is a convertible structure. Therefore, when the LCD screen 64 is moved to the third location shown in FIG. 7, the user can conveniently carry the laptop computer 52 along with the LCD monitor module 54.

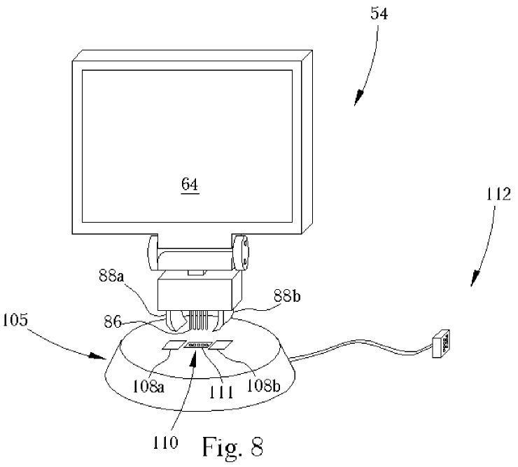

Please refer to FIG. 8 in conjunction with FIG. 4. FIG. 8 is a second structure diagram of the LCD monitor module 54 shown in FIG. 2. The LCD monitor module 54 further can be installed on a cradle 105. The structure of the LCD monitor module 54 is shown in FIG. 4, and the detailed description about the LCD monitor module 54 is not repeated for simplicity. The cradle 105 has a plurality of connecting devices 108a, 108b and an output port 110. There are many receiving holes 111 disposed on the output port 110, and the output port 110 is electrically connected to a connector 112. Therefore, when connecting devices 108a, 108b are adapted to connecting devices 88a, 88b, the LCD monitor module 54 is fixed on the cradle 105, and the output port 110 is electrically connected to the protruding pins 86. In other words, the LCD monitor module 54 can be used as a pure LCD monitor. That is, the connector 112 of the cradle 105 is capable of being connected to a display controller of any computer host for receiving video signals. Then, the video signals are passed to the LCD monitor module 54 through the output port 110 and the protruding pins 86. In the end, the LCD screen 64 successfully shows images corresponding to the received video signals. For example, the LCD monitor module 54 can be first installed on the cradle 105 to function as an LCD monitor, and then the connector 112 is used to connect a video output port of the laptop computer 52. In addition to the LCD screen 58, the display control 60 of the laptop computer 52 further transmits video signals to the LCD monitor module 54. The laptop computer 52 can display images on both of the LCD screen 58 and the LCD screen 64 of the LCD monitor module 54.

Please note that the output port 68 and the connecting devices 70a, 70b in the above embodiment are disposed on the top housing 56a of the laptop computer 52. However, many sets of the output port and the connecting devices 70a, 70b can be disposed on the top housing 56a and the bottom housing 56b of the laptop computer 52. Therefore, the user is capable of installing the LCD monitor module 54 on a proper position of the laptop computer 52 according to the user's demand. In addition, if the display controller 60 supports a multi-channel display mode, the user can simultaneously install a plurality of LCD monitor modules on the laptop computer 52 that has many sets of the output port and the connecting devices 70a, 70b according to the user's demand. Furthermore, the laptop computer 52 in the preferred embodiment does not include a digitizer. The LCD monitor module 54 is adopted to provide the laptop computer 52 with the digitizer 82 for expanding functionality of the laptop computer 52. For example, the laptop computer 52 complies with a specification defined for a tablet PC. However, if the laptop computer 52 itself already has a digitizer, that is, the laptop computer 52 is a tablet PC originally, the LCD monitor module 54 according to the present invention also can be installed on the above-mentioned laptop computer 52 for providing the laptop computer 52 with an additional input device. In the preferred embodiment, a desktop computer can be used to replace the laptop computer 52. In other words, when the output port 68 and the connecting devices 70a, 70b are positioned on the desktop computer, the user also can install the LCD monitor module 54 on the desktop computer. Similarly, functionality of the desktop computer is expanded to have two monitors for displaying images and a digitizer for inputting signals. Concerning the output port 86 and the latch device 68, the output port 86 has receiving holes 72, and the latch device 68 has protruding pins 86 corresponding to the receiving holes 72. However, the protruding pins 86 can be disposed on the output port 68, and the latch device 68 has the receiving holes 72 corresponding to the protruding pins 86. With regard to the connecting devices 70a, 70b, they belong to receiving holes. Concerning the connecting devices 88a, 88b, they belong to protruding pins. However, the connecting devices 88a, 88b can be disposed on the top housing 56a, and the corresponding connecting devices 70a, 70b can be disposed on the latch device 68.

As shown in FIG. 4, the protective glass 78 is positioned above the LCD screen 64 to strengthen hardness of the LCD screen 64 for preventing the LCD screen 64 from being damaged by external impact. In addition, when the user touches the protective glass 78, the hardness of the protective glass 78 can prevent the display quality of the LCD screen 64 from being degraded by the pressure exerted by the user. For instance, the LCD screen 64 includes a top glass layer and a bottom glass layer mainly used to clamp liquid crystal molecules. Thin film transistors are formed on the bottom glass layer, and a color filter is attached to the top glass layer. For the LCD screen 64 having a large size, an external force easily presses the liquid crystal molecules between the top glass layer and the bottom glass layer if no protective glass 78 is installed. Further, the display quality associated with the outputted images is greatly affected. However, it is well-known that the LCD screen 64 further has spacers used to support the top glass layer and the bottom glass layer. Therefore, with the help of the spacers, the hardness of the LCD screen 64 can also be strengthened. That is, the LCD monitor module 54 in the preferred embodiment can exclude the protective glass 78 from its structure. For example, concerning the LCD screen 64 having a small size, the spacers mentioned above is strong enough to achieve desired hardness.

In contrast to the prior art, the computer system according to the present invention includes an LCD monitor module that is removably installed on a housing of a laptop computer. The LCD monitor module is a convertible structure so that a user is convenient to carry the laptop computer along with the LCD monitor module. Both of the LCD monitor module and the laptop computer make use of an identical connecting interface. In addition, the LCD monitor module is directly installed on the laptop computer by the connecting interface. Therefore, the LCD monitor module does not occupy much space, and it is convenient for the user to install the LCD monitor module on the laptop computer with no adapter needed. The LCD monitor module provides the laptop computer with another display screen for supporting a dual channel display mode. At the same time, the LCD monitor module also provides the laptop computer with a digitizer for supporting a handwriting input. With regard to the dual channel display mode, because the LCD monitor module is a specialized add-on device for the laptop computer, related software run on the laptop computer can easily control images displayed on the LCD monitor module according to a hardware specification of the LCD monitor module. In addition, with regard to the handwriting input, because the digitizer is parallel to the display screen, the digitizer and the display screen, therefore, are precisely orientated. Furthermore, the LCD monitor module can also be fixed on a specific cradle to function as a standard LCD monitor. Therefore, when the user does not add the LCD monitor module to the laptop computer, the spare LCD monitor module with the cradle then becomes a display device for other computer hosts. To sum up, it is easy for the user to operate the computer system according to the present invention. In addition, the computer system according to the present invention has greater practicability.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A computer system comprising:
a computer host comprising:
a first housing;
a first display screen disposed on the first housing for displaying images;
a display controller electrically connected to the first display screen for outputting a first video signal to initiates the first display screen to display images corresponding to the first video signal; and
an output port disposed on the first housing, the output port being electrically connected to the display controller for transmitting a second video signal generated from the display controller; and
a display module comprising:
a second housing;
a latch device disposed on the second housing being capable of removably fixing the second housing on the first housing;
a second display screen disposed on the second housing for display images; and
an input port being capable of removably connecting the output port of the computer host for receiving the second video signal to initiate the second display screen to display images corresponding to the second video signal.

2. The computer system of claim 1 wherein the second display screen comprises a liquid crystal display (LCD) panel.

3. The computer system of claim 2 wherein the display module further comprises a digitizer disposed inside the second housing, and the digitizer is electrically connected to the computer host through the output port of the computer host.

4. The computer system of claim 3 wherein the second display screen further comprises a protective glass disposed above a display surface of the LCD panel for protecting the LCD panel.

5. The computer system of claim 3 wherein the LCD panel is disposed above the digitizer.

6. The computer system of claim 5 wherein the digitizer is an electromagnetic digitizer.

7. The computer system of claim 3 wherein the digitizer is disposed above a display surface of the LCD screen.

8. The computer system of claim 7 wherein the digitizer is a resistive digitizer.

9. The computer system of claim 1 wherein the computer host is a portable computer.

10. The computer system of claim 1 wherein the display module further comprises a cradle, and the latch device is capable of removably fixing the display module on either the cradle or the computer host.

11. The computer system of claim 10 wherein the input port of the display module is capable of being electrically connected to a display driving device for receiving video signals generated from the display driving device to initiate the second display screen to display images corresponding to the video signals.

12. The computer system of claim 11 wherein the display driving device is the display controller of the computer host.

13. The computer system of claim 1 wherein the output port of the computer host is positioned on a portion of the first housing corresponding to the first display monitor, and the input port of the display module is positioned on the latch device.

14. The computer system of claim 1 wherein the latch device comprises a pivot unit rotationally connected to the second display screen for adjusting a location associated with a display surface of the second display screen.
